(19) United States
(12) Patent Application Publication
(10) Pub. No.: US 2004/0266021 A9
(43) Pub. Date: Dec. 30, 2004

(54) Multicapillary fraction collection system and method

(76) Inventors: Andras Guttman, San Diego, CA (US); Liang Shi, San Diego, CA (US); Xun Wang, San Diego, CA (US)

Correspondence Address: JENKINS & WILSON, PA, 3100 TOWER BLVD, SUITE 1400, DURHAM, NC, 27707, US

(21) Appl. No.: 10/058,963

(22) Filed: Jan. 28, 2002

Related U.S. Application Data
(63) Continuation-in-part of application No. 10/047,461, filed on Jan. 14, 2002.
(63) Continuation-in-part of application No. 10/047,438, filed on Jan. 14, 2002.
(60) Provisional application No. 60/340,802, filed on Dec. 14, 2001.
(60) Provisional application No. 60/264,574, filed on Jan. 26, 2001.

(51) Int. Cl. G01N 27/26; G01N 27/447; G01N 1/18

(52) U.S. Cl. 436/177; 204/601; 204/603; 204/604; 204/605; 204/615; 204/451; 204/452; 204/453; 204/455; 204/465; 436/161; 422/70; 436/178; 422/101; 422/82.01; 435/287.1; 435/287.2; 435/288.6

(57) ABSTRACT

A method of injecting, isolating and separating mixed analytes from one or more samples. The method includes collecting successive fractions from each of a plurality of samples at discrete points in time. Fractions may be analyzed at the time of collecting, or later, using one or more detector systems. In one embodiment, a processor controls the elutions of fractions by modulating the migration field in a separation pathway. The processor also controls distribution of the fraction into a particular collection well of a plurality of collection wells.

### RELATED APPLICATIONS AND CLAIM OF PRIORITY

This application claims priority to U.S. Provisional Patent Application serial No. 60/264,574, entitled METHOD AND APPARATUS FOR TESTING SAMPLES UTILIZING A SAMPLING APPARATUS AND ONE OR MORE SEPARATE DETECTORS, and filed on Jan. 26, 2001, the specification of which is hereby incorporated by reference.

This application claims priority to U.S. Provisional Patent Application serial No. 60/340802, entitled FRACTION COLLECTION SYSTEM AND METHOD, and filed on Dec. 12, 2001, the specification of which is hereby incorporated by reference.

This application claims priority to U.S. patent application Ser. No. ______, entitled THIN FILM ELECTROPHORESIS APPARATUS AND METHOD, filed on Jan. 14, 2002, the specification of which is hereby incorporated by reference.

The specification of U.S. patent application Ser. No. ______, entitled NANOPOROUS MEMBRANE REACTOR FOR MINIATURIZED REACTIONS AND ENHANCED REACTION KINETICS, and filed on Jan. 14, 2002, is hereby incorporated by reference.

### TECHNICAL FIELD

This document relates generally to analysis of samples, including large scale sampling of biological test samples. More specifically, the present invention relates to a method and apparatus for analyzing fractions or analytes from a sample.

### BACKGROUND OF THE INVENTION

Large scale testing and analysis is important to many industries, including biotechnology, medical diagnostics, and pharmaceuticals. For example, manufacturers in the biotechnology industries implement automated laboratory systems, such as high throughput processing, to test and analyze large numbers of samples.

In some cases however, analytical or preparatory techniques are not suitable for use with automated processing systems. Consequently, certain procedures are performed separately from the automated system and involve some amount of human intervention, thus increasing the production time and cost.

Capillary electrophoresis (CE), for example, has been used in both analytical and preparative applications. Among the advantages of CE is the ability to quickly separate similar compounds on a nanoliter scale. For example, CE can be used with mixtures of proteins, macromolecules, nucleotides, enantiomers, and chiral molecules. Pharmaceutical, agricultural, and chemical industries routinely use CE in analytical applications, as well as in research and development.

The biotechnology industry, for example, has capitalized on the ability of CE to quickly analyze small volumes of material. Capillary electrophoresis can be used with nucleic acids, separations and analysis. There remains, however, a need for a rapid process that identifies and isolates large volumes of material, such as is generated by pharmacogenomics and the human genome project.

Advances in cloning techniques, for example, have enabled the genomic sequencing of a organisms. A sample of DNA, or a fragment thereof, from a particular organism, can be cloned and then analyzed using CE to determine the DNA sequences. Also, CE may be used to isolate a particular DNA fragment for cloning. For example, CE may isolate a preparative amount of a particular DNA fragment from a mixed DNA population. This purified fragment can then be inserted into recombinant DNA plasmid, which then clones the corresponding protein.

Conventional slab gel electrophoresis (SGE) is unsuitable for high volume analysis of DNA sequences. Each sample derived from SGE is physically cut from the slab and separately analyzed, thus requiring human intervention. Consequently, these and other disadvantages render SGE incompatible with an automated, high throughput system.

Limitations in the speed, volume and efficiency of CE technology have impaired efforts to streamline or automate genomic processes. Thus, there remains a need for faster, higher volume, and more efficient methods of DNA separation, isolation and cloning. In addition, there is a need for an improved system and method for analyzing biological and chemical samples that yields high resolution and rapid results.

### SUMMARY

The present subject matter is directed to apparatuses, systems and methods for performing high throughput collection of fractions or analytes. In one embodiment, analysis, or detecting, is integrated into the present system. In one embodiment, detection is performed as a subsequent process after having collected the various fractions.

In one embodiment, the present subject matter includes a method of analyzing fractions from one or more samples. Each fraction is a part, or portion, of the original sample from which it is obtained or collected. The original sample can be any material provided for testing, including a biological sample (for example, a pure compound or a mixture of compounds) wherein the identity, or amount of each component of the sample, is unknown. In one embodiment, the method involves providing one or more samples to a sampling apparatus that collects successive fractions from each of the samples at discrete points in time. The discrete points in time may be equally or unequally spaced from one another. In one embodiment, the method involves removing the fractions from the sampling apparatus and then analyzing the fractions with one or more detector systems that are separate from the sampling apparatus.

In one embodiment, the present subject matter includes a fraction analysis system. The system includes an apparatus that collects successive fractions from each of one or more samples at discrete points in time. The system also includes one or more detectors, each of which are separate from the fraction collection apparatus and configured to analyze the successive fractions.

In one embodiment, after removal from the fraction collection apparatus, the collected fractions are available for subsequent processing in another process. The present subject matter may be automated.

In one embodiment, relevant fractions are combined or isolated from the analytical spectra to produce a purified product on a preparatory scale. Analytical and preparatory modes may be performed on the same test sample undergoing one pass through the sampling apparatus.

In one embodiment, the detection system is separate from the collection system. In one embodiment, the detection system, or detector, is integrated with the collection of fractions.

In one embodiment, the present subject matter may be used with multiple detection systems or simultaneously use different detection systems. For example, in one embodiment, a CE instrument simultaneously processes 100 samples, thus producing 100 separate fractionated collections, whereby each collection has 384 individual fractions in a specimen plate. As another example, in one embodiment, the present subject matter allows detecting 25 fractionated collections by a first detection system (e.g. fluorescence), detecting another 25 fractionated collections by a second detection system (e.g. UV-VIS), and detecting the remaining fractionated collections by a third detection system (e.g. mass spectrometry).

In one embodiment, a method of testing or analyzing a sample utilizing continuous sampling techniques enables the direct conversion of analog data into digital signals. The resulting digital data preserves the analog data and allows analysis (e.g., spectral analysis) at a later time, thus allowing uncoupling of the detector system from the sampling apparatus. In one embodiment, an unknown sample is continuously analyzed by a method that includes selecting a predetermined time period and waiting for a period of delay. The delay period is produced, in part, by latency of migration through the present system. The delay period is determined by the sampling rate. The sampling rate is selected to be at least twice the highest frequency of the smallest discrete moiety present in the unknown sample. Pursuant to Nyquist's theorem, the original data is preserved by sampling at twice the highest frequency. In one embodiment, a sampling rate greater than twice the highest frequency is used. Successive fractions are collected at predetermined intervals of time. Fraction collection continues for the predetermined time period.

In one embodiment, the present subject matter includes a time sequenced testing apparatus having a sample clock, a sample injector, a sampling apparatus, a fraction collector, a computer, and a detector. The sample clock is configured to mark a time period sequence. The sample injector is adapted to apply one or more samples to a sampling apparatus. The sampling apparatus provides fractions for collecting. In one embodiment, the sampling apparatus includes a separation pathway such as, for example, a capillary or channel. The fraction collector is coupled with, and coordinated with the output of the sampling apparatus, and is adapted to receive successive fractions wherein the size and number of the fractions are determined by the time period sequence. The computer is adapted to coordinate the sample clock with the fraction collector and the sampling apparatus. The detector is uncoupled from the sampling apparatus and configured to detect the fractions received from the fraction collector after the time period sequence has expired.

In one embodiment, the apparatus also includes a capillary, a cathode electrode, an anode electrode, a power supply, a buffer solution and a plurality of actuators or movers. The capillary is adapted to perform capillary electrophoresis. The cathode and anode electrodes are positioned parallel to respective ends of the capillary. The power supply, adapted for high voltage, is configured to create an electric gradient across the cathode and anode. The buffer solution is comprised of components non-reactive to the sample. The actuators are adapted to facilitate transfer of the capillary and electrode from a sample to the buffer solution, and from the capillary and electrode to the fraction collector.

In various embodiments, the present subject matter allows separating, identifying, and isolating high volumes of samples using nanoliter amounts of sample material while limiting human interaction and achieving high resolution. The present subject matter can be used with DNA separation, isolation and cloning.

Other aspects of the invention will be apparent on reading the following detailed description of the invention and viewing the drawings that form a part thereof.

### BRIEF DESCRIPTION OF THE DRAWINGS

In the drawings, like numerals describe substantially similar components throughout the several views. Like numerals having different letter suffixes represent different instances of substantially similar components.

FIG. 1 illustrates a block diagram of a method in accordance with the present subject matter.

FIG. 2 illustrates a schematic diagram of a CE apparatus in accordance with the present subject matter.

FIG. 3 illustrates a schematic diagram of a multiple-capillary CE apparatus in accordance with the present subject matter.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents.

By way of overview, the present system includes a separation pathway having an input end coupled to a reservoir, or well, of sample material. The sample material is migrated through the separation pathway and fractions are eluted from the output end of the separation pathway. The eluate is received in a collection reservoir or well. The fractions move through the separation pathway under a migration field. The migration field may be created by an electric potential, a pneumatic source, a vacuum source, or a magnetic source, or other field source. Consider the case of an electric field. In this embodiment, the electric field is created by an electric potential applied by electrodes in contact with the input end and the output end of the separation pathway. In one embodiment, a first electrode is coupled to the input end of the separation pathway and a second electrode is coupled to the collection reservoir. In one embodiment, the collection reservoir includes a plurality of wells, such as for example, a 96-well plate. The second electrode is coupled to each well of the 96-well plate. At a predetermined frequency, the output end of the separation pathway is brought into contact with each successive well of the collection reservoir, thus setting up an electric field within the pathway. Fractions eluted from the separation pathway migrate into the contacted well and when the separation pathway is moved away from the collection reservoir, the migration is halted. A controller coupled to the present system controls the frequency of the contact between the separation pathway and the collection plate. In addition, the controller adjusts the relative positions to cause each successive fraction to be deposited into a different well of the collection plate. In this manner, the migratory field is modulated and each well of the collection plate receives a particular fraction eluted at a particular time.

In one embodiment the controller adjusts the position of the output end of the separation pathway and the collection plate remains stationary. In one embodiment, the separation pathway remains stationary and the controller adjusts the position of the collection plate. In one embodiment, both the separation pathway and the collection plate are adjusted by the controller. In one embodiment, the first and second electrodes are affixed to the input and output ends, respectively, of the separation pathway and the controller modulates the applied voltage.

In one embodiment, a plurality of separation pathways are provided with each pathway having an input coupled to a sample well and each pathway having an output coupled to a multi-well collection plate. For example, in one embodiment, 96 separation pathways are coupled to a 96-well input plate and the output of each separation pathway is coupled to a 96-well collection plate. Thus, the output end includes 96 collection plates. In one embodiment, each of the 96 collection plates are positioned independently and in another embodiment, each of the 96 collection plates are positioned as a group. An actuator coupled to the collection plate may be coupled to, and operated by, the controller. The actuator may include an x-axis actuator and a y-axis actuator or a rotary actuator. The actuator may also be coupled to the output end of each separation pathway.

The intensity of the migration field, in one embodiment is controlled by making, or breaking electrical contact with the collection plate. In one embodiment, the field intensity is controlled by making and breaking contact at the input end. Other arrangements are also contemplated, such as, for example, a pneumatic system in which applied air pressure is used to elute fractions from the separation pathway. In one embodiment, the migration field is provided by a vacuum source. In one embodiment, a magnetic field, produced by current in electrical windings in the proximity of, or surrounding, the separation pathway, is energized to create a migration field. The field magnitude may be modulated between two intensity levels. For example, in one embodiment, the field magnitude is modulated between zero and a particular upper value. As another example, the field magnitude may be modulated between two nonzero values.

A fraction detector, or detector system, may be positioned at the output end of the separation pathway or the collection well. In one embodiment, fractions are collected without use of a detector and subsequent processing includes analysis by a detector. In various embodiments, the detector includes a fluorescent detector, an ultraviolet-visible (UV-VIS) detector, a mass spectrometry detector, an immunoassay detector, an electrochemical detector, a radiochemical detector, a nuclear magnetic resonance (NMR) detector or a surface plasmon resonance (SPR) detector.

Capillary Electrophoresis Testing Method

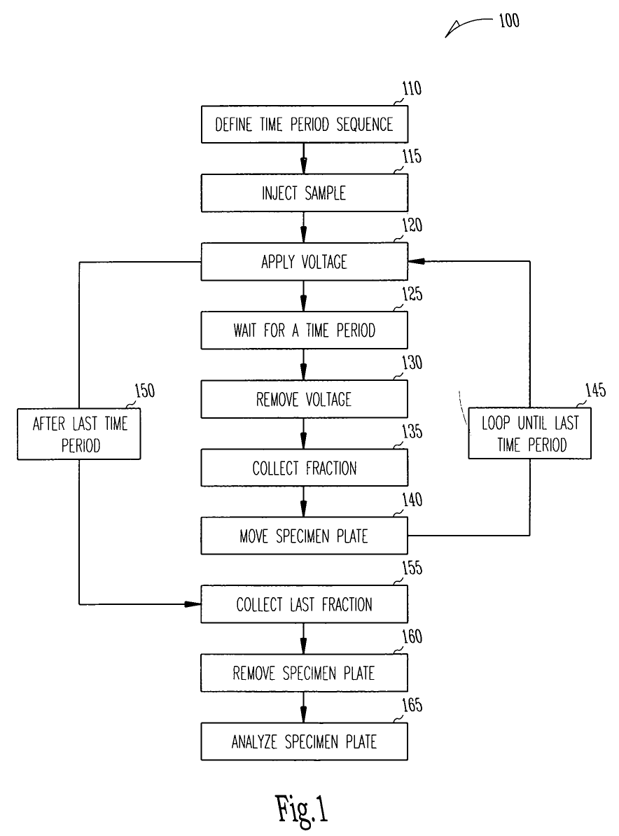

FIG. 1 depicts a testing method 100 practiced according to the present invention using CE analysis. It will be appreciated that other separation pathways are also contemplated, including for example, a micro-fabricated or nano-fabricated separation pathway. At 110, a time period sequence is defined. Nyquist's theorem for sampling serves as a guide for determining a sampling rate. According to Nyquist the sampling rate must be at least twice the highest frequency of the smallest discrete moiety present in the sample in order to reconstruct the original signal. Here, the analog data is preserved digitally by continuous sampling at a rate greater than twice the highest frequency. The sampling rate is thus, a function of the time period.

Consider an example wherein CE is used to separate individual fragments of different size DNA (one base different). The defined time period is determined by choosing a sampling rate that captures no more that one base pair per sampling. Thus, the defined time period captures the smallest discrete moiety in the sampling. The summation of all these time periods over the entire time a sample is analyzed constitutes the time period sequence. The time period sequence may include a finite number of equally spaced time periods. In one embodiment, the time periods differ logarithmically, exponentially, or geometrically. In one embodiment, the sequence of time periods is experimentally determined. The time period sequence may be defined by any method known in the art of continuous sampling.

At 115, a test sample is introduced into the CE instrument. In one embodiment, the test sample is injected, however, other methods of applying the sample to the CE instrument are also contemplated. The sample may be robotically or manually introduced. It will also be appreciated that other analytical or preparatory devices are also contemplated. For example, immunoassay, or high performance liquid chromatography (HPLC), or other assay techniques may also be used. The sample may include a mixture of proteins, macromolecules, nucleotides, carbohydrates, enantiomers, small molecule libraries or natural compounds.

At 120, a voltage is applied across the CE capillary. In one embodiment, the medium within the capillary, or separation pathway, and the characteristics of the test sample determine the voltage applied.

At 125, a time period elapses. The time period is determined by the time period sequence at 110. During this time period, an electric gradient exists across the separation pathway due to the voltage applied at 120. The gradient resolves and separates the individual components in the test sample. In one embodiment, a two hour time period is established and fraction collection occurs every 30 seconds after an initial delay period of one hour.

At 130, the voltage from the capillary is removed following expiration of the time period at 125. Thus, the present subject matter achieves continuous sampling. In one embodiment, sampling does not occur after removal of the voltage from the capillary and the electric gradient is removed. Thus, a fraction is captured when the voltage is applied.

At 135, a fraction is collected corresponding to the time period during which the electric gradient exists across the capillary. The collected fraction includes the material collected during the time period in which analysis occurs. In one embodiment, the fraction is collected in an individual well of a standard specimen plate, for example, a 96-well or 384-well specimen plate. The fraction may be manually or robotically collected. Other devices used to hold fractions are contemplated within the present invention. For example, test tubes, blotting paper, or individual vials may be used.

In one embodiment, after collecting a fraction at 135, the specimen plate is moved into position to receive the next fraction, at 140. For example, the specimen plate may be moved robotically. In one embodiment, the separation pathway, or capillary, is moved to manipulate the output into the next well of the specimen plate. In one embodiment, the methods from 120 through 140 are repeated through each successive time period 125 until the last time period expires in the time period sequence defined at 110. The method collects fractions when an electric gradient is applied across the capillary, thus ensuring continuous sampling of the test sample throughout the entire analysis. Consequently, each fraction has been captured within a discrete time period on the specimen plate. In one embodiment, the sampling time is synchronized with the mobility change of the analyte.

After the last time period, at 150, the last fraction is collected, at 155. In one embodiment, at 160, the specimen plate is removed from the CE instrument. After removal from the CE instrument, at 165, the contents of the specimen plate are detected. In one embodiment, detection includes, for example, charge-coupled device (CCD) arrays using an ultraviolet (UV) or fluorescence monitor may detect the entire specimen plate at one time. Alternatively, the specimen plate may be detected individually or row by row. In one embodiment, the specimen plate undergoes more than one detection process. For example, the specimen plate may be monitored first by V, then fluorescence, and then by mass spectrometry. Other detection modes, such as conductivity, electrochemical, or radioactive means are also contemplated. In one embodiment, the detector includes a fluorescent detector, an ultraviolet-visible (UV-VIS) detector, a mass spectrometry detector, an immunoassay detector, an electrochemical detector, a radiochemical detector, a nuclear magnetic resonance (NMR) detector or a surface plasmon resonance (SPR) detector.

In one embodiment, the method according to FIG. 1 is practiced using a CE instrument that separates individual base pairs of DNA. Once a detector detects the fractions in the specimen plate, a spectra is produced of the separation in which each individual peak corresponds to an individual base pair. From this analytical spectra, desired base pairs may be isolated and the corresponding fraction amplified by polymerase chain reaction (PCR), thus creating preparative amounts of isolated and purified base pairs.

In one embodiment, the CE analysis may be automated. For example, detection, at 165, may be accomplished using a high throughput system. Further, creating preparatory amounts of a specific fraction in the specimen plate may also occur robotically using a high throughput system. Accordingly, the present subject matter provides for an automated process of testing large numbers of samples in a high throughput system. In one embodiment, detection is uncoupled from the sampling apparatus and both analytical and preparatory modes may be practiced on a single pass though the sampling apparatus. More than one detection device may be utilized on the same specimen plate. In this way, high volumes of samples may be analyzed using multiple detection systems in both an analytical and preparatory mode using a small amount of material.

Capillary Electrophoresis Sampling Apparatus

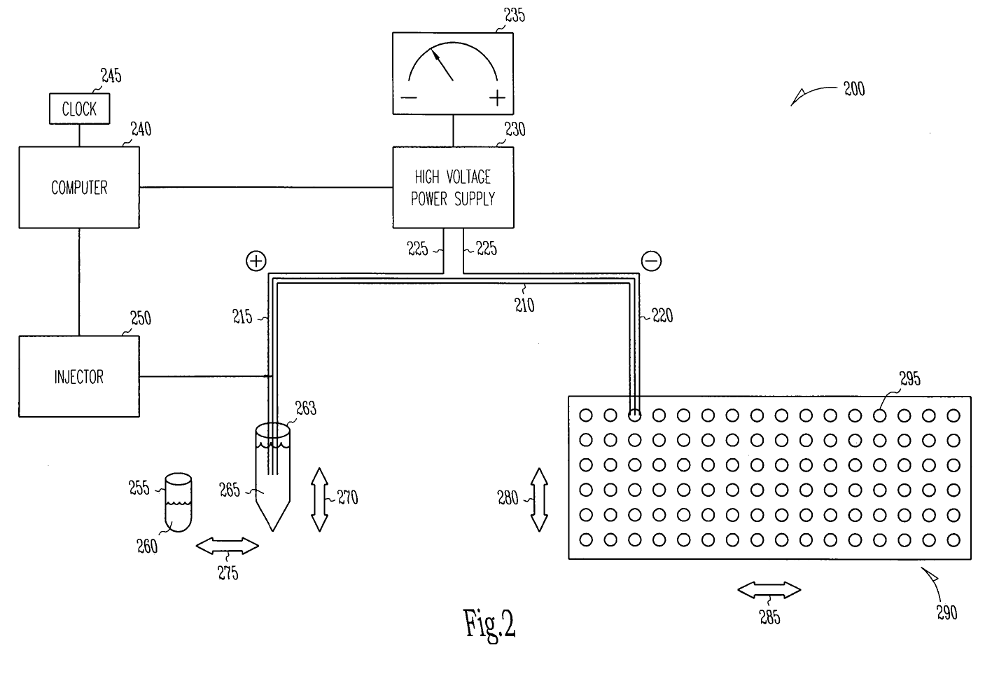

In accordance with the present invention, a diagram of system 200 is provided in FIG. 2. In the embodiment shown, sampling apparatus 200 includes a CE instrument used to separate, isolate, and resolve mixtures of proteins, macromolecules, nucleotides, enantiomers, and chiral molecules based on the differences in molecular charged to mass ratios. In this embodiment, the CE instrument is configured to sequence DNA fragments and isolate individual base pairs.

In one embodiment, capillary 210 is filled with a molecular sieving matrix, such as polyacrylamide, polyethylene oxide or other types of polymers. Other types of gel may also be used. It will also be appreciated that other CE techniques such as isoelectric focusing, isotachophoresis (ITP), and hydrophrobicity (micellar electrokinetic capillary chromatography, MECC), and other CE techniques may be used. Coupled to capillary 210 is electrode 225. Electrode 225 includes anode 215 at one end and cathode 220 at the other end of the capillary. By means of power supply 230, a high voltage is applied across electrode 225, creating a positive charge at anode 215 and a negative charge at cathode 220. This in turn creates an electric gradient across capillary 210. Voltmeter 235 is connected to power supply 230 and indicates the voltage applied to electrode 225.

In one embodiment, electrode 225 and capillary 210 are positioned inside sample reservoir 255 holding test sample 260. Injector 250 coordinates injection of test sample 260 into capillary 210. Other injectors 250 and sample holders 255 may be used to apply sample 260 to capillary 210. For example, an automated injector system in which the sample holder 255 includes a syringe may also be used.

In one embodiment, sample holder 255 includes an individual well in a 96-well, or larger or smaller, specimen plate.

Vertical sample mover 270 and horizontal sample mover 275, (also referred to as actuators) are represented in the figure by directional arrows. In one embodiment, mover 270 and mover 275 are positioned to move sample holder 255, buffer holder 263, or capillary 210, such that capillary 210 and electrode 225 are in contact with the contents of reservoir 255 or 263. For example, vertical and horizontal movers 270 and 275 are operable to move sample container 255 out of contact with capillary 210 and electrode 225 after the test sample is injected. Movers 275 and 270 position buffer container 263 such that buffer solution 265 is in contact with electrode 225 and capillary 210. Movers 270 and 275 may be manual or robotic. In one embodiment, the actuators include one or more linear or rotary motors.

In one embodiment, computer 240 coordinates the actions of injector 250, power supply 230, volt meter 235, and time period clock 245, and movers 270, 275, 285 and 280. Computer 240 executes a computer program to coordinate the electric field gradient intensity with the collecting of fractions. In one embodiment, system 200 is configured such that injector 250 applies sample 260 to capillary 210. Movers 270 and 275 position buffer container 263 such that capillary 210 and electrode 225 is immersed in buffer solution 265. In this embodiment, the anodic end of electrode 225 is immersed in buffer solution 265.

Computer 240, in one embodiment, includes a processor with memory, a user input device (such as a keyboard or mouse), an output device (such as a display or printer). The memory contents can include program memory or data derived from the present subject matter.

In one embodiment, computer 240 instructs power supply 230 to apply a voltage across electrode 225 such that the anodic end 215 of the electrode carries a positive charge while the cathodic end of the electrode 220 carries a negative charge. Thus, an electric gradient forms across capillary tube 210. The electric gradient is maintained across electrode 210 for a defined time period marked by clock 245. After the time period marked by clock 245 expires, the voltage supplied by power supply 230 is removed, thereby removing the electric gradient across capillary 210. Once the electric field is removed, analysis by CE is suspended or interrupted. Interruption of the migration field may include terminating the field or modulating the field between two or more non-zero intensity levels.

During the time period, buffer solution is drawn up from buffer container 263 and drawn through capillary 210 and collected in fraction collector plate 290 in an individual collector well 295. In one embodiment, fraction collection occurs while the voltage is applied across electrode 225. Fraction collector plate 290 may include, for example, a 96-well specimen plate, an array of vials, or other specimen plates.

After the time period marked by clock 245 expires and power supply 230 has removed the voltage across electrode 225, vertical mover 280 and horizontal mover 285 position fraction collector plate 290 such that a next individual collector well 295 is positioned to receive the next fraction from capillary 210. After fraction collector plate 290 is positioned to receive the next fraction from capillary 210, clock 245 begins measuring a successive time period triggering application of a voltage across electrode 225 supplied by power supply 230. During this time period, the next fraction is collected from capillary 210 by the successive individual fraction well 295.

The time periods marked by clock 245 may be uniform or different for each successive time period. For example, each time period measured may be 30 seconds in duration, or, alternatively, the first time period may be 90 seconds to account for the void volume of the capillary 210, and successive fractions may be collected on a 30 second basis. As another example, time periods may be measured logarithmically, geometrically or exponentially. In one embodiment, the sampling time is synchronized with the mobility change of the analyte. For example, where mobility of an analyte is half as fast, the time period is twice as long.

In one embodiment, after sampling is complete, movers 280 and 285 transport the fraction collection plate 290 to a detection processing area. A second sample may be analyzed while the first sample is being detected at another processing station. In one embodiment, each fraction collector plate undergoes multiple detection methods after removal from system 200.

Multiple-Capillary and Capillary Electrophoresis Apparatus

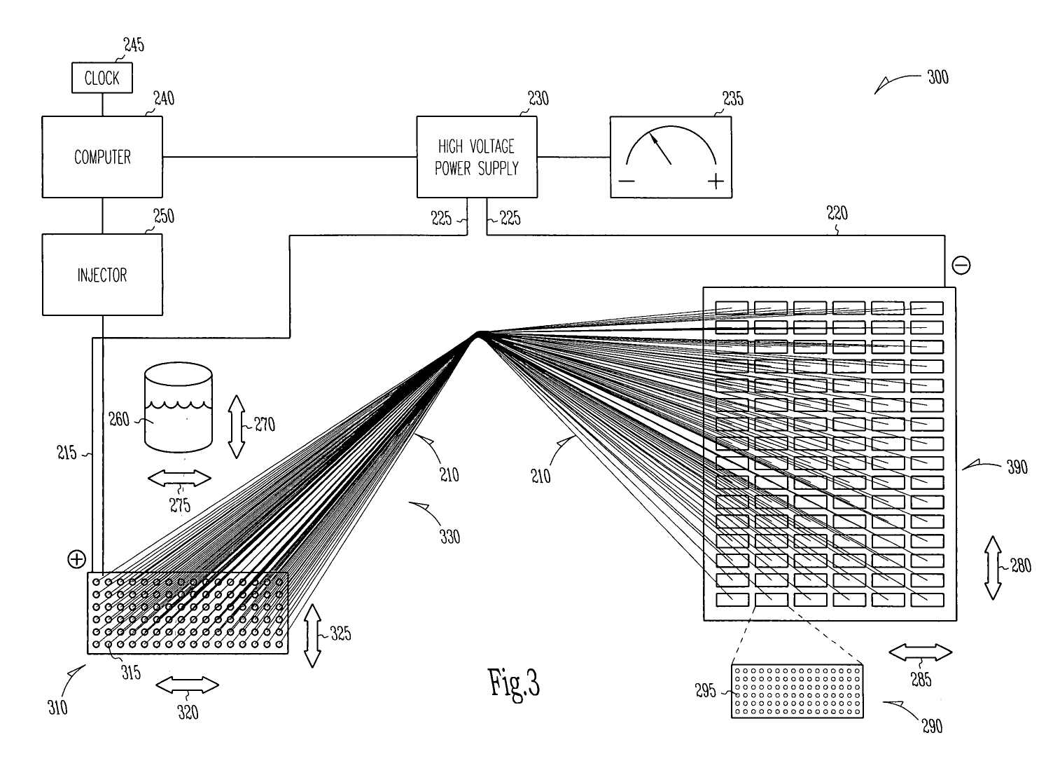

System 300 in accordance with one embodiment of the present subject matter is illustrated in FIG. 3. In this embodiment, system 300 includes multiple capillaries by which multiple test samples are simultaneously analyzed.

The embodiment illustrated in FIG. 3 employs an array of capillaries 330 or separation pathways. The separation pathways may including a plurality of individual capillaries 210 which may include microfabricated or nanofabricated channels. A corresponding array of electrodes 335, including individual electrodes 225, are coupled to capillary array 330 such that each electrode 225 is coupled to a corresponding capillary 210. Each individual capillary 210 and its corresponding electrode 225 is in contact with an individual test sample well 315. Collectively, these individual test sample wells 315 form an array of sample wells 310. In one embodiment, this array of sample wells 310, in which each individual sample well 315 contains a test sample 260, may be a 96-well sample plate. Other sample arrays are also contemplated. For example, a collection of vials or test tubes may be used.

Each test sample 260 contained in individual sample well 315 may be identical to other test samples contained in sample array 310 or the test samples may vary across the array. For example, each individual sample well within the array of sample wells may contain a different DNA fragment to be sequenced. Conversely, non-redundant, expressed sequence tag (EST) libraries may be constructed used in connection with other high throughput processes.

The 96-well specimen plate does not limit the number of capillaries that may be used in this apparatus at any one time. For example, a 384-well sample plate may be used in which 384 capillaries and 384 varied or identical samples may be simultaneously analyzed. Fractions for each capillary 210 are collected in fraction collector plate array 390, wherein array 390 includes a plurality of fraction collector plates 290 configured to receive fractions. Each individual capillary 210 corresponds to an individual fraction collection plate 290. Movers 280 and 285 coordinate positioning of the fraction collector plates relative to the capillaries, to receive successive fractions.

In one embodiment, multiple samples are analyzed and detected at a subsequent processing station. For example, detection may occur as part of a high throughput system such as a CCD array configured for ultraviolet-visible (UV-VIS) or fluorescence detection. In one embodiment, multiple detection systems are used. For example, some fractions may undergo UV-VIS detection while other fractions undergo fluorescence detection and still other fractions undergo both UV-VIS and fluorescent detection.

The present invention may be practiced in both an analytical mode and a preparatory mode. In one embodiment, a sample undergoes CE analysis, thus creating multiple fractions on a specimen plate. At a later time, the specimen plate may be detected using laser-induced fluorescence, thus generating an analytical spectra of the processed sample. From this spectra, certain peaks corresponding to certain fractions may be amplified and duplicated, for example, using PCR or cloning. In this manner, preparatory amounts of certain fractions have been generated from the same specimen plate that provided the analytical data.

In the figure, plate 310 is shown coupled electrically to power supply 230 by electrode 215. In addition, array 390 is shown coupled electrically to power supply 230 by electrode 220. Each plate 290 within array 390 is coupled electrically to electrode 220. In the embodiment shown, plates 310, 290 and array 390 are electrically conductive, and fabricated of such materials as a metal or conductive ceramic. In one embodiment, plate 310 is fabricated of non-conductive, or semiconductive, material and each well, or reservoir, 315 is lined with an electrically insulative material and electrode 210 is coupled to each well 315 by an individual electrode. In one embodiment, array 390, or plates 290, are fabricated of non-conductive, or semiconductive, material and each well or reservoir 295 in plate 290 is lined with an electrically insulative material and electrode 220 is coupled to each well 295 by an individual electrode.

Any number of fractions may be collected without regard to correlating a detected peak to a specific fraction during the analysis.

Alternate Embodiments

In one embodiment, each separation pathway is associated with a particular collection plate having a plurality of collection wells. Thus, 96 collection plates are used in a system having 96 separation pathways. In this manner, each separation pathway is individually controllable relative to the associated collection plate for that pathway. In one embodiment, the separation pathway is stationary and the collection plate is positionable by an actuator. The collection plates are mounted in a frame or otherwise synchronized to move together. In one embodiment, the collection plates are stationary and the separation pathways are positionable by an actuator. In one embodiment, each separation pathway is positioned independently of the position of other pathways. In one embodiment, each collection plate is positioned independently of the position of other plates. In one embodiment, one actuator, or set of actuators, controls movement of a collection plate (or array of collection plates) along a first axis, such as an x-axis. A second actuator, or set of actuators, controls movement of a separation pathway along a second axis, such as a y-axis. Other arrangements of actuators are also contemplated.

The actuators may include one or more linear or rotary actuators, or motors. For example a first linear motor controls movement of a collection plate along an x-axis and a second linear motor controls movement of the plate along a y-axis. Rotary actuators may also be used to control the relative position of the separation pathway relative to the collection plate. The actuators may include a pneumatic cylinder, a lead screw, a hydraulic cylinder, an electric solenoid or a magnetic actuator.

Conclusion

The above-described system provides, among other things, a system, apparatus and method for collection and analysis with high resolution and high throughput.

It will be appreciated that the methods described herein may be performed in different orders than described and that portions of a method may be repeated.

It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A system comprising:
a separation pathway having a first end and a second end;
a sample well in communication with the first end;
one or more collection wells, wherein the second end is adapted to communicate with at least one collection well of the one or more collection wells;
a power supply having a first electrode and a second electrode adapted to create an electric field between the first end and the second end;
a first actuator adapted to adjust a first position of the second end relative to the plurality of collection wells; and
a controller coupled to the first actuator and adapted to modulate a potential between the first end and the second end and adapted to control the first position.

2. The system of claim 1 further comprising a detector in communication with the second end.

3. The system of claim 2 wherein the detector includes a fluorescent detector, an ultraviolet-visible (UV-VIS) detector, a mass spectrometry detector, an immunoassay detector, an electrochemical detector, a radiochemical detector, a nuclear magnetic resonance (NMR) detector or a surface plasmon resonance (SPR) detector.

4. The system of claim 1 wherein the first electrode is coupled to the first end.

5. The system of claim 1 wherein the first electrode is coupled to the sample well.

6. The system of claim 1 wherein the second electrode is coupled to the second end.

7. The system of claim 1 wherein the second electrode is coupled to the one or more collection wells.

8. The system of claim 1 wherein the separation pathway includes a capillary or microchannel.

9. The system of claim 1 wherein the actuator includes a motor coupled to the plurality of collection wells.

10. The system of claim 1 wherein the first actuator includes a first motor adapted to displace the plurality of collection wells along a first axis and a second motor adapted to displace the plurality of collection wells along a second axis.

11. The system of claim 1 wherein the first actuator includes a motor coupled to the second end.

12. The system of claim 1 wherein the first actuator includes a first motor adapted to displace the second end along a first axis and a second motor adapted to displace the second end along a second axis.

13. The system of claim 1 wherein the controller includes a processor.

14. The system of claim 1 further including:
a plurality of sample wells wherein the sample well in communication with the first end includes a selected sample well of the plurality of sample wells;
a second actuator adapted to adjust a second position of the first end relative to the plurality of sample wells; and
wherein the controller is adapted to control the second position.

15. The system of claim 1 wherein the second actuator includes a motor coupled to the plurality of sample wells.

16. The system of claim 1 wherein the second actuator includes a third motor adapted to displace the plurality of sample wells along a first axis and a fourth motor adapted to displace the plurality of sample wells along a second axis.

17. The system of claim 1 wherein the second actuator includes a motor coupled to the first end.

18. The system of claim 1 wherein the second actuator includes a third motor adapted to displace the first end along a first axis and a fourth motor adapted to displace the first end along a second axis.

19. The system of claim 1 wherein the controller includes a clock.

20. The system of claim 1 wherein the controller includes a voltage controller coupled to the power supply.

21. A computer implemented method comprising:
applying a sample to an input of a separation pathway;
generating a migratory field in the separation pathway;
eluting an analyte of the sample from the separation pathway;
collecting the analyte in a collection well;
interrupting the migratory field after collecting commences; and
repeating the collecting and the interrupting, at a predetermined time interval, for a successive analtye and a successive collection well.

22. The method of claim 21 wherein repeating the collecting and interrupting, at the predetermined time interval includes repeating the collecting and interrupting, at substantially uniformly spaced time intervals.

23. The method of claim 21 further comprising synchronizing the collecting and interrupting with the mobility of the analtye.

24. The method of claim 21 further comprising analyzing the analtye prior to collecting.

25. The method of claim 21 wherein injecting the sample includes injecting a biological sample.

26. The method of claim 21 wherein injecting a sample includes injecting a mixture of proteins, macromolecules, nucleotides, carbohydrates, enantiomers, small molecule libraries or natural compounds.

27. The method of claim 21 wherein creating a migratory field includes applying a potential to the separation pathway.

28. The method of claim 21 wherein creating a migratory field includes applying a pressure to the separation pathway.

29. The method of claim 21 wherein creating a migratory field includes drawing a vacuum in the separation pathway.

30. The method of claim 21 wherein collecting includes positioning the separation pathway relative to the collection well.

31. The method of claim 21 wherein repeatedly interrupting the migratory field includes adjusting a potential within the separation pathway.

32. The method of claim 21 further comprising establishing the predetermined time interval as a function of a composition of the separation pathway.

33. A system comprising:
a plurality of separation pathways, each separation pathway having a first end and a second end;
a plurality of sample wells, wherein each sample well is in communication with a first end of a separation pathway;
a power supply having a first electrode and a second electrode adapted to create an electric field between the first end and the second end of each separation pathway;
for each separation pathway, a plurality of collection wells wherein each collection well is adapted to communicate with a second end of the separation pathway;
for each separation pathway, a first actuator adapted to adjust a position of the second end relative to the plurality of collection wells; and
a controller coupled to the first actuator and adapted to modulate the electric field and adapted to control the position.

34. The system of claim 33 further comprising a detector coupled to each separation pathway of the plurality of separation pathways.

35. The system of claim 33 further comprising a detector coupled to each collection well of the plurality of collection wells.

36. The system of claim 33 wherein the plurality of separation pathways includes a multichannel capillary.

37. The system of claim 33 wherein the plurality of separation pathways includes a plurality of microchannel pathways.

38. The system of claim 33 wherein the plurality of separation pathways includes a plurality of nanochannel pathways.

39. The system of claim 33 wherein the plurality of sample wells includes a multi-well plate.

40. The system of claim 33 wherein the plurality of collection wells includes a multi-well plate.

41. The system of claim 33 further comprising a frame wherein each of the plurality of collection wells for each separation pathway is secured to the frame.

42. The system of claim 40 wherein the first actuator is coupled to the frame.

43. The system of claim 33 wherein the first actuator is coupled to the plurality of separation pathways.

44. The system of claim 33 wherein the first actuator is coupled to the plurality of collection wells.
